(19) United States
(12) Patent Application Publication
(10) Pub. No.: US 2002/0176147 A1
(43) Pub. Date: Nov. 28, 2002

(54) High speed electro-optic modulator

(76) Inventor: Alexander B. Romanovsky, San Jose, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/156,241

(22) Filed: May 24, 2002

Related U.S. Application Data
(60) Provisional application No. 60/293,840, filed on May 25, 2001.

(51) Int. Cl. G02F 1/03; G02F 1/07

(52) U.S. Cl. 359/245

(57) ABSTRACT

An optical apparatus comprises an input port for receiving light, an output port for outputting light, and an optical path extending from the input port to the output port. The optical path is at least partially comprised of polycrystalline electro-optic material. The optical apparatus further comprises a field generator that generates a field in the polycrystalline electro-optic material. The polycrystalline electro-optic material is configured with respect to the input port and the output port, and is responsive to the field, to cause at least a substantial portion of light propagating along the optical path to deviate from the optical path along a plurality of deviant optical paths. The plurality of deviant optical paths do not pass through the output port, thereby reducing light output through the output port.

### PRIORITY APPLICATION

This application claims priority under 35 U.S.C. §119(e) from U.S. Provisional Patent Application Serial No. 60/293,840, filed May 25, 2001.

### BACKGROUND OF THE INVENTION

1. Field of the Invention

The present invention is directed to apparatuses and methods for varying the propagation of light through a polycrystalline electro-optic or magneto-optic material subjected to an electric or magnetic field.

2. Description of the Related Art

Electro-optic materials can be used in devices to manipulate the transmission of optical signals therethrough by applying an electric field to the electro-optic material. For example, an optical valve or a variable attenuator can be constructed by placing a slab of lead lanthanum zirconate titanate (“PLZT”) between two perpendicularly-oriented or “crossed” polarizers. When an electric field is applied to the PLZT, the polarization of light passing therethrough will rotate, allowing the amount of light transmitted through the optical valve to be controlled.

Devices that include polarizers, such as the optical valve or variable attenuator described above, are inherently dependent on the polarization of the incoming light. Because it is desirable to reduce or eliminate polarization dependent loss in many high speed communications applications (i.e., between 1 GHz and 40 GHz), such optical valves are not generally used as high speed modulators. While polarization-independent high speed modulators can be constructed using lithium niobate or gallium arsenide (e.g., using a Mach-Zender interferometric technique), such modulators are complex and expensive to fabricate. Accordingly, there is a need for a simpler, less expensive high speed optical modulator that can operate at high signaling frequencies and that can be integrated with waveguide structures on a planar wafer. Particularly, such modulators are needed for use with the dense wavelength division multiplexing (“DWDM”) equipment used in optical communications networks.

### SUMMARY OF THE INVENTION

One aspect of the present invention is an optical apparatus comprising an input port for receiving light, an output port for outputting light, and an optical path extending from the input port to the output port. The optical path is at least partially comprised of polycrystalline electro-optic material. The optical apparatus further comprises a field generator that generates a field in the polycrystalline electro-optic material. The polycrystalline electro-optic material is configured with respect to the input port and the output port, and is responsive to the field, to cause at least a substantial portion of light propagating along the optical path to deviate from the optical path along a plurality of deviant optical paths. The plurality of deviant optical paths do not pass through the output port, thereby reducing light output through the output port.

Another aspect of the present invention is a method comprising transmitting light through a polycrystalline electro-optic material from an input port to an output port along an optical path. The method further comprises reducing the flux density of the light output through the output port by activating the polycrystalline electro-optic material such that the flux density at a plurality of locations around the output port is increased.

Yet another aspect of the present invention is a method comprising propagating light through a volume of polycrystalline electro-optic material, and outputting at least a portion of the light propagating through the volume of polycrystalline electro-optic material. The method further comprises applying a sufficiently high electric or magnetic field to scatter the propagated light and to reduce the portion of light output.

### BRIEF DESCRIPTION OF THE DRAWINGS

FIG. 1A is a perspective view of a preferred embodiment of a system for producing modulated light comprising a light source and a high speed electro-optic modulator.

FIG. 1B is a cross-sectional schematic view of the system for producing modulated light depicted in FIG. 1.

FIG. 2 is a schematic representation of a central region of the high speed electro-optic modulator of FIG. 1, comprising polycrystalline electro-optic material such as PLZT.

FIG. 3 is a schematic diagram of two orthogonal high speed electro-optic modulators coupled together via an optical fiber.

FIGS. 4A and 4B are schematic diagrams of alternative embodiments of high speed electro-optic modulators configured to propagate light substantially parallel to applied electric field lines.

FIG. 5 is a schematic diagram of a high speed electro-optic modulator configured for use with planar channel waveguides.

### DETAILED DESCRIPTION OF THE PREFERRED EMBODIMENTS

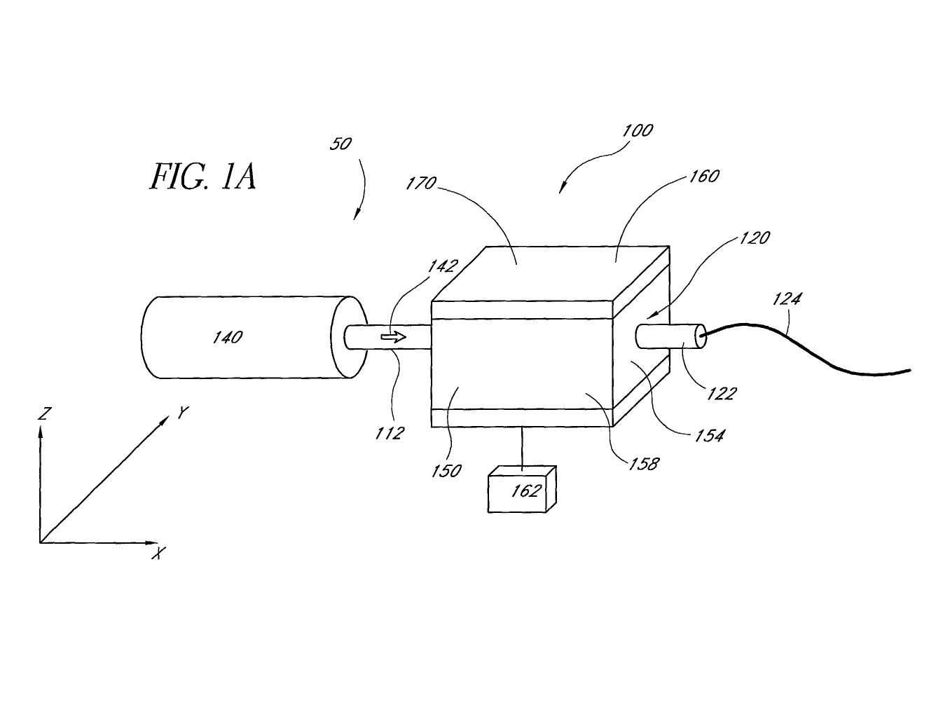

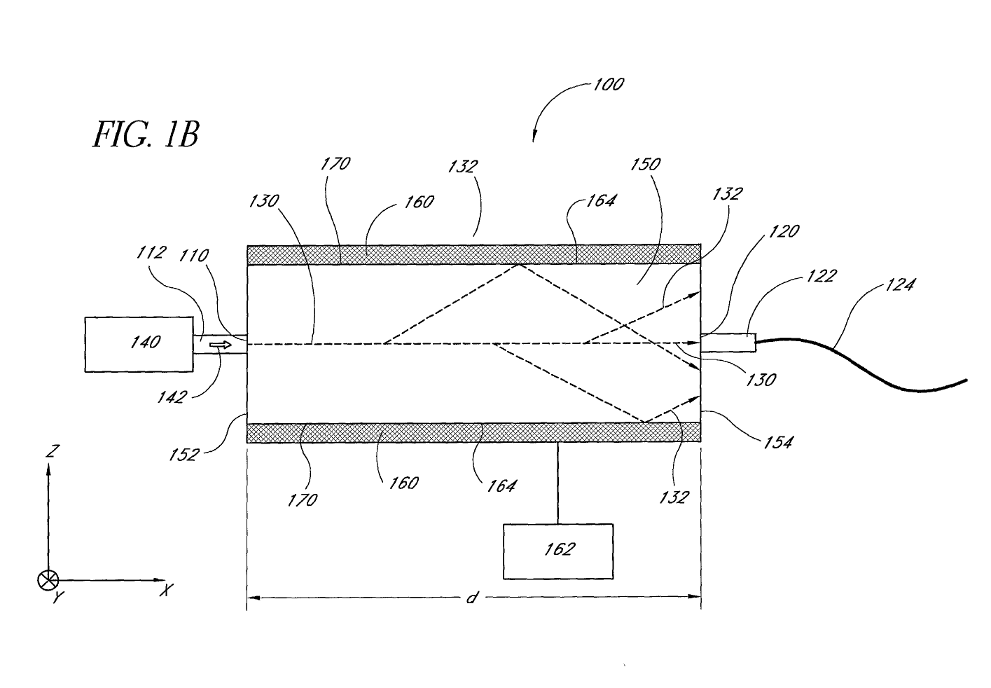

FIGS. 1A and 1B schematically illustrate one embodiment of a system 50 for producing modulated light. As used herein, “modulated” light refers broadly to light having a characteristic, such as intensity or frequency, that is varied. Examples of modulated light include an optical signal which is switched on and off, an optical signal that has a manually-adjustable or machine-controlled intensity, and an optical signal with an intensity that varies according to a digital or analog control signal. Likewise, a modulator used to produce modulated light is a device for modulating or varying a characteristic of light such as intensity or frequency. A modulator may be a device employed in optical communications systems for superimposing data on an optical signal by varying the intensity or frequency of the light in an analog or digital fashion. Another example of an optical modulator is a variable attenuator, which may be controlled directly by a user or automatically through a computer, a microprocessor, or other electronics. As illustrated in FIGS. 1A and 1B, the system 50 for producing modulated light includes an electro-optic modulator 100. This modulator 100 introduces intensity variations.

Again referring to FIGS. 1A and 1B, electro-optic modulator 100 further comprises an input port 110 and an output port 120 separated by a distance d. A direct optical path 130 extends from the input port 110 to the output port 120. The modulator 100 further includes a central region 150 between input port 110 and output port 120 such that optical path 130 passes therethrough. This central region 150 preferably comprises polycrystalline electro-optic material. In alternate embodiment, the central region 150 may comprise polycrystalline magneto-optical material. Referring to the coordinate system defined in FIG. 1A, this central region 150 has an input face 152 and output face 154 parallel to the yz plane, top and bottom faces 170 parallel to the xy plane and sides faces 158 parallel to the xz plane. However, in alternative embodiments, the polycrystalline electro-optic material 150 may be formed into other shapes.

In a preferred embodiment, the input port 110 and the output port 120 are located on the input face 152 and the output face 154, respectively, of the polycrystalline electro-optic material 150. The input port 110 has associated therewith an aperture on the input face 152 into which light is received. Likewise, the output port 120 has associate therewith an aperture on the output face 154 through which light is coupled from the central region comprising electro-optic material 150 to an output coupler 122.

The system 50 for producing modulated light includes a light source 140 optically coupled to the modulator 100. In one preferred embodiment, the light source 140 comprises a laser configured to produce a collimated light beam 142 with a wavelength of 1550 nm, since 1550 nm light is commonly used to communicate digital data (such as digitized voice signals, for example). In other embodiments, the light source 140 comprises a laser with a different configuration and may be a laser diode or a fiber laser. The light source 140 may also be a light-emitting diode producing uncollimated light. The particular light source 140, however, is not limited to these examples recited herein and may include other devices or systems that produce light that are well-known in the art or yet to be developed. The light source 140 may for example produce spatially coherent or incoherent light as well as temporally coherent or incoherent light. Although the wavelength of the light source 140 is not critical to the operation of the electro-optic modulator 100, the polycrystalline electro-optic material 150 is preferably substantially optically transmissive to the selected wavelength.

The input port 110 receives light from light source 140. In the preferred embodiment illustrated in FIGS. 1A and 1B, light is coupled from the light source 140 to the input port 110 via an input coupler 112. This optical coupler 112 preferably comprises a collimator that produces a substantially collimated beam. In one preferred embodiment, this input coupler 112 comprising a collimating lens. This collimator 112 preferably has a Rayleigh range greater than or about equal to the distance d between input port 110 and output port 120. As used herein, the Rayleigh range of a beam is the distance over which the beam propagates while its diameter increases by a factor of about \sqrt{2}. In other embodiments, collimator 112 has a Rayleigh range shorter than the distance d. In such embodiments, the insertion loss of the modulator 100 will be increased. In fiber optic applications, insertion losses for high speed modulators are often between about 5 to 6 dB, and may even be higher than about 10 dB. Such loss of signal is may be compensated by usage of a higher power light source 140.

One example of a particularly suitable input collimator 112, which has a diameter of about 100 μm and a Rayleigh range between about 2 to 4 mm, is available from Horizon Photonics, Inc., of Walnut, Calif. Such collimators are discussed more fully in U.S. patent application Ser. No. 10/140,519 (Attorney Docket No. TOPTICS.004CP5), filed by Romanovsky on May 7, 2002 and entitled “Solid State Free Space Switch Array on a Substrate”, now U.S. Pat. No. ______, the entire disclosure of which is hereby incorporated herein by reference.

The input collimator 112 is not restricted to any particular type or design and may comprise, for example refractive, reflective, and/or diffractive elements. In one preferred embodiment, the input coupler 112 comprises a graded index lens (“GRIN lens”). In still other embodiments, in which light source 140 produces a sufficiently collimated light beam, light from light source 140 is coupled directly into the input port 110 without passing through any intervening optical components that shape the beam. In still other embodiments, light from light source 140 is coupled into an optical fiber (not shown) that transmits the light to input collimator 112, from which the light is passed to the input port 110, possibly directly to the input face 152.

As described above, the input face 152 has an aperture through which the preferably substantially collimated light beam 142 passes. This aperture is a smaller region within the larger input face 152 in embodiments wherein the collimated light beam 142 is smaller than the input face 152. In other embodiments, wherein the collimated light beam 142 is larger than the input face 152, the input aperture comprises the entire input face 152. In still other embodiments, wherein the input coupler 112 is close to or butt up against the input face 152, the exit aperture of the input coupler 112 defines the input aperture on the central region 150 of the modulator 100. In certain embodiments, the region of the input face 152 comprising the input port 110 is polished or coated with an antireflective (“AR”) coating to minimize insertion losses.

Likewise, the output face 154 has an output aperture through which a portion of the light within the polycrystalline electro-optic material 150 passes. This aperture has a spatial extent which limits and thereby controls transmission of light through the central region 150 of the modulator 100. Light not incident on this output aperture will not be coupled through the output port 120. In a preferred embodiment, output coupler 122 is configured to collect light passing through the output port 120 and to transmit a portion of such collected light to other optical components. Specifically, output coupler 122 transmits light within a certain “numerical aperture” or “acceptance angle” that passes through its aperture to remote locations or to signal switching systems. Light passing through the output port 120 at an angle greater than the acceptance angle of the output coupler 122 or beyond the aperture of the output coupler 122 will not be transmitted.

For example, in the preferred embodiment illustrated in FIGS. 1A and 1B, light that has passed through output aperture is collected by the output coupler 122, which transmits the portion of the collected light within the acceptance angle of the output coupler 122 to optical fiber 124 for transmission, for example, to remote locations or to signal switching systems. In such embodiments, the output aperture is determined by the input aperture of the output coupler 122. However, in other embodiments, the output aperture may correspond to an opening in a mask disposed over at least a portion of the output face 154.

In the embodiment illustrated in FIGS. 1A and 1B, the output coupler 122 is a collimator with the same or similar properties as input collimator 112. However, in other embodiments, the output coupler 122 may comprise a lens or other optical element configured to focus the light passing through the output port 120 onto a detector, fiber, waveguide, or other optical component. The optical coupler 122 may be a refractive, reflective, and/or diffractive element. In one preferred embodiment, the optical coupler comprises a graded index lens (“GRIN lens”). In still other embodiments, the output coupler 122 may comprise one end of an optical fiber or other waveguide, wherein light within the acceptance angle of the optical fiber or waveguide is transmitted therethrough.

As described above, the central region 150 of the electro-optic modulator 100 comprises polycrystalline electro-optic material disposed between the input port 110 and the output port 120. This polycrystalline electro-optic material may be formed into a rectangular slab or other cylindrical shape such as a right circular cylinder and may be faceted, smooth, varying in thickness and/or have curved surfaces. The central region 150 of polycrystalline electro-optic material is not restricted to any particular shape or configuration. In one preferred embodiment, the polycrystalline electro-optic material 150 comprises lead lanthanum zirconate titanate (“PLZT”), although other polycrystalline electro-optic materials may be used in other embodiments. The central optical path 130 extends in a substantially straight line between the input port 110 and the output port 120, and thus the optical path 130 passes at least partially through the polycrystalline electro-optic material 150.

Preferably, the polycrystalline electro-optic material 150 has dimensions sufficient to allow the collimated light beam 142 to travel along the optical path 130 in substantially free space propagation, without direct interaction with the electrodes 160 or the top, bottom 170 and sides 158 of the central region 150. Accordingly, the beam propagating through the central region 150 is not confined as it would be in a waveguide but propagates as if in free space. Free space propagation through another type of device is described in U.S. patent application Ser. No. 10/140,519 (Attorney Docket No. TOPTICS.004CP5), filed by Romanovsky on May 7, 2002 and entitled “Solid State Free Space Switch Array on a Substrate”, now U.S. Pat. No. ______, which is hereby incorporated herein by reference in its entirety.

The free space mode of propagation referred to above is readily understood when compared to the guided mode of propagation. The guided mode of propagation corresponds to the state of light propagating within or being “piped” through a waveguide. As is well known, waveguides have boundaries from which the light therein is reflected as it propagates. A fiber waveguide, for example, comprises a core and a cladding surrounding the core. In one model, light within the fiber is represented as rays propagating within the core and reflecting from the cladding by means of total internal reflection. In this manner, light is constrained within the waveguide as it propagates. The cladding, or more generally the sidewalls of the waveguide, establish boundary conditions for the light within the guide. A given waveguide will support a specific set of guided modes, characteristics of which are determined by these boundary conditions, which themselves are determined by the geometry of the waveguide.

By contrast, light propagating in a free space mode is not so constrained. The propagation of light in a free space mode is substantially unaffected by any boundaries confining the beam. Light can propagate in a free space mode in a liquid, solid, or gaseous medium. The free space mode can exist, for example in optically transmissive materials such as PLZT. The boundaries of the propagation media, however, are widely spaced in comparison to the size of the optical beam passing therethrough. The beam is therefore said to be in the free space mode and not the guided mode.

Accordingly, the central region 150 preferably is between about 0.5 mm and 3 mm wide and between about 100 μm and 1 mm high. In addition, in certain embodiments, the distance d between input port 110 and output port 120 is within the Rayleigh range of the input collimator 112. In one preferred embodiment, this distance d is approximately about 3 mm but may range, for example, between about 0.5 mm and 10 mm. The dimensions of the central region 150, however, are not limited to those recited herein. In alternative embodiments, the polycrystalline electro-optic material 150 may have dimensions to cause the collimated light beam 142 to propagate in a guided mode.

In the design illustrated in FIGS. 1A and 1B, the electro-optic modulator 100 further comprises first and second electrodes 160 positioned on the top and bottom faces 170 of the polycrystalline electro-optic material 150. Electrodes 160 are preferably metallic conductors, but may be comprised of other types of conductors or semiconductors such as for example RuO₂, Ir₂O₃ and La_{0.5}Sr_{0.5}C_{0.3}Oₓ. Applying a voltage across the electrodes 160 produces an electric field within the polycrystalline electro-optic material 150 that is transverse to the optical path 130 (i.e., that is parallel to the z axis as defined in FIG. 1A). In one embodiment, for example, the electric field strength may range between about 0 V/μm and 5 V/μm, one preferred range for activating the device 100 being between about 1 V/μm and 5 V/μm. In alternative embodiments, other configurations for generating a field within the polycrystalline electro-optic material 150 can be provided.

Although the electrodes 160 are in contact with the polycrystalline electro-optic material 150 in the embodiment illustrated in FIGS. 1A and 1B, one of ordinary skill in the art will recognize that the electrodes 160 need not be in contact with the polycrystalline electro-optic material 150 to produce an electric field therein. In addition, because light propagates through the electro-optic modulator 100 in a free space mode in one preferred embodiment, as discussed above, the electrodes 160 need not have any particular optical properties in such embodiments. Specifically, while the inner surfaces of the electrodes 160 may be reflective, the electrodes 160 may alternatively be optically transparent or substantially absorbing in other configurations.

In certain embodiments, a modulation signal source 162 is connected to at least one of the electrodes 160. The modulation signal source 162 can be an analog or digital electronic signal source, in optical communications applications, such as, e.g., a telephone coder/decoder (“codec”) or a data modulator/demodulator (“modem”). In alternative applications, the modulation signal source 162 may be a baseband binary digital signal. The modulation signal source 162 provides the electro-optic modulator 100 with the modulation signal at which the collimated light beam 142 is to be modulated. This source 162 can also be used to adjust and control the transmission through the central region 150 in the case where variable attenuation at a slow rate is desired.

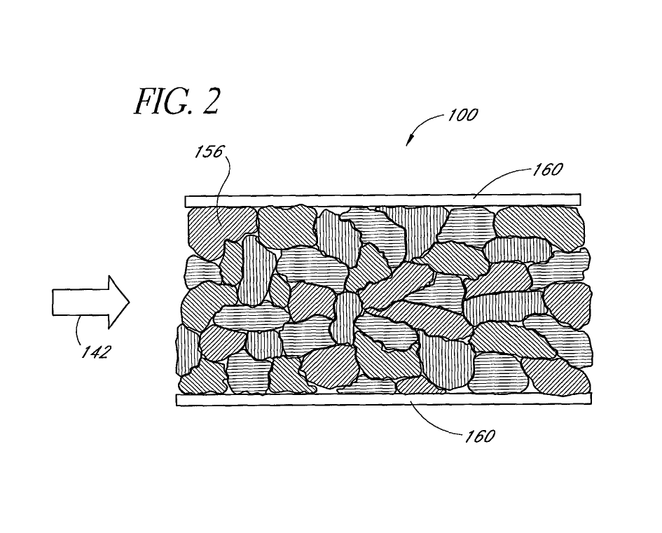

Without subscribing to any particular theory regarding how the electro-optic material modulates the collimated light beam 142, the following physical and operational characteristics of polycrystalline electro-optic materials are set forth. FIG. 2 is a schematic illustration of a preferred embodiment of the internal structure of the polycrystalline electro-optic material in the central region 150 of the electro-optic modulator 100. In such embodiments, the polycrystalline electro-optic material comprises a plurality of distinct regions 156 with random orientations. In FIG. 2, the size of these regions 156 are exaggerated for clarity, and different regions are cross-hatched differently to illustrate their varying orientations.

When no electric field is applied to the polycrystalline electro-optic material 150, the regions 156 all have approximately the same refractive index. However, when an electric field is applied to the polycrystalline electro-optic material 150, the various regions 156 exhibit different change in refractive index. The change in refractive index of a specific region depends on the strength of the applied electric field, as well as on the orientation of the specific region with respect to the applied electric field. In addition, the change in refractive index also depends on the relative orientation of the applied electric field and the polarization of the collimated light beam. For example, PLZT generally exhibits a decrease in refractive index for light polarized parallel to the applied electric field, and an increase in refractive index for light polarized perpendicular to the applied electric field. However, the magnitude of the increase in refractive index associated with the perpendicular polarization component is only about one-third of the magnitude of the decrease in refractive index associated with the parallel polarization component. Further discussion of the birefringent properties of PLZT can be found in U.S. patent application Ser. No. 10/140,083 (Attorney Docket No. TOPTICS.004CP4), entitled “Optical Switching Network and Network Node and Method of Optical Switching”, filed by Romanovsky on May 6, 2002, now U.S. Pat. No. ______, the entire disclosure of which is hereby incorporated herein by reference.

Thus, when an electric field is applied to the polycrystalline electro-optic material 150, or when a magnetic field is applied to the magneto-optic material, index change boundaries arise within the polycrystalline electro-optic material 150, and specifically, along the optical path 130. For birefringent materials such at PLZT, such index change boundaries are dependent on the polarization of light passing therethrough.

Therefore, when a collimated light beam 142 is passed through the polycrystalline electro-optic material 150, and when no electric field is applied to the polycrystalline electro-optic material 150, the collimated light beam preferably 142 passes through the polycrystalline electro-optic material 150 with substantially no or only a small amount of attenuation. However, when an electric field is applied to the polycrystalline electro-optic material 150, the index change boundaries along optical path 130 may theoretically cause refraction, partial reflection, dispersion and/or scattering, possibly at the region boundaries. These and other effects may cause a portion of the collimated light beam 142 to deviate from central optical path 130 to one of a plurality of deviant optical paths 132, thereby reducing the collimation of the collimated light beam 142. As illustrated in FIG. 1B, the shifting of optical energy from optical path 130 to deviant optical paths 132 reduces the amount of optical energy passing through output port 120. These deviant rays 132 may not be incident on the output aperture and thus not pass therethrough. Alternatively, the deviant rays 132 may be incident thereon at an angle that exceeds the acceptance angle of, for example, the output coupler 122, an optical fiber or waveguide or other optical device that restrict angle of light passing through the output port 120. Therefore, by increasing the electric field within the polycrystalline electro-optic material 150, and transferring optical power away from the central path 130, the amount of light coupled from output port 120 can be decreased.

Thus, as described above, the intensity of the light passing through the electro-optic modulator 100 can be modulated by modulating the electric field applied to the polycrystalline electro-optic material 150. Modulation of the electric field can be accomplished by electrically connecting the modulation signal source 162 to the electrodes 160. As explained above, in one preferred embodiment, the polycrystalline electro-optic material 150 comprises PLZT. Because PLZT is a polycrystalline solid, its reaction to applied electric fields is fast, thereby allowing the indices of refraction within the regions 156 to be changed rapidly. However, in alternative embodiments different polycrystalline electro-optic material or magneto-optic materials may be used and thus the central region 150 should not be limited to comprising PLZT or any other particular solid or liquid material. In such alternative embodiments, the different polycrystalline electro-optic or magneto-optic material may be responsive to an electric field, a magnetic field or both, to induce the regions 156 to undergo a change in refractive index.

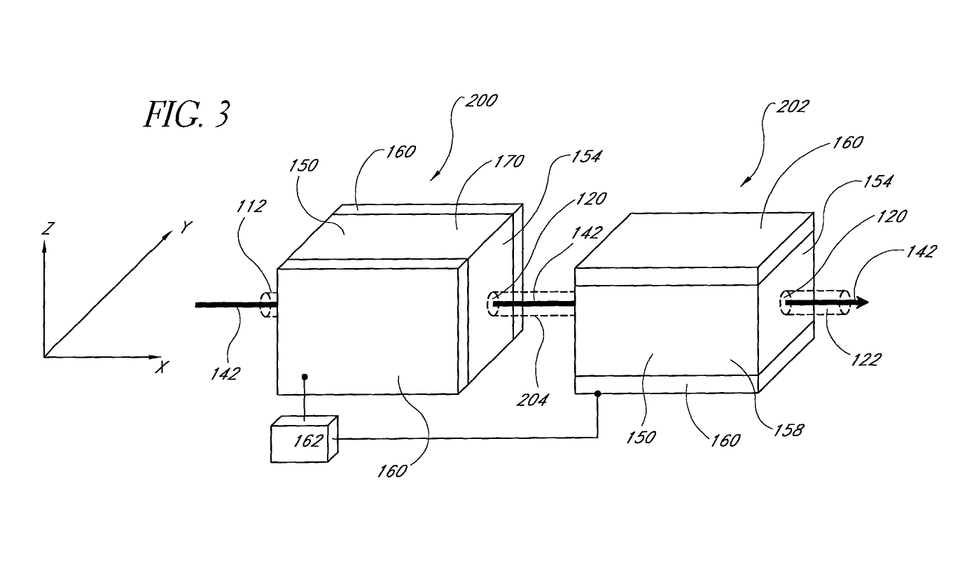

FIG. 3 illustrates an alternative system design in which two (first and second) perpendicularly oriented electro-optic modulators 200, 202 are coupled together via optical fiber 204. This embodiment is configured to further allow the system for producing modulated light to operate substantially independently of the polarization of the input light beam 142. As described above, certain polycrystalline electro-optic materials, such as PLZT, exhibit birefringence, and thus could cause a single electro-optic modulator 100 to have a slight dependence on the polarization of the incoming collimated light beam 142. Specifically, PLZT exhibits a decrease in refractive index for light polarized parallel to the applied electric field, and an increase in refractive index for light polarized perpendicular to the applied electric field. However, the magnitude of the increase in refractive index associated with the perpendicular polarization component is only about one-third of the magnitude of the decrease in refractive index associated with the parallel polarization component. Similarly, attenuation produced in the electro-optic modulator 100, 200, 202 has been demonstrated to be higher for light polarized parallel to the induced electric field than for light polarized perpendicular to the electric field.

However, by positioning two perpendicularly oriented electro-optic modulators 200, 202 in series, dependence on the polarization of the incoming collimated light beam 142 can be reduced or substantially eliminated. As the collimated light beam 142 passes through the two perpendicularly oriented electro-optic modulators 200, 202, the polarization component parallel to the y axis (as defined in FIG. 3) is parallel to the applied electric field in the first electro-optic modulator 200, and is perpendicular to the applied electric field in the second electro-optic modulator 202. Likewise, the polarization component parallel to the z axis (as defined in FIG. 3) is perpendicular to the applied electric field in the first electro-optic modulator 200, and is parallel to the applied electric field in the second electro-optic modulator 202. Thus, both polarization components experience both the smaller increase and larger decrease in refractive index and resultant attenuation.

Although the two modulators depicted in FIG. 3 are optically connected together by an optical fiber 204, other types of waveguides such as for example a planar waveguide may used to link the two devices. Alternatively, a light pipe or other optical element such as a lens may be used, and thus a free space region may separate the two modulators 200, 202. Accordingly, light propagating between the two modulator 200, 202 may be guided or unguided. In an alternative embodiment, the two modulators 200, 202 are juxtaposed adjacent one another with no optical element therebetween. The output face 154 of the first modulator 200 may be butted up against the input face 152 of the second modulator 202. In other designs, a single region 150 of electro-optic material may have associated with it two pairs of electrodes 160, one pair on top and bottom 164 associated with a first section of the electro-optic material, and another pair on opposite sides of the electro-optic material associated with an adjacent section. The two pairs of electrodes 160 would induce perpendicularly directed electric fields in the respective adjacent sections of the electro-optic material. In other embodiment, however, spacing the two modulators 200 and 202 apart by a distance may reduce possible interactions between the two modulators 200 and 202.

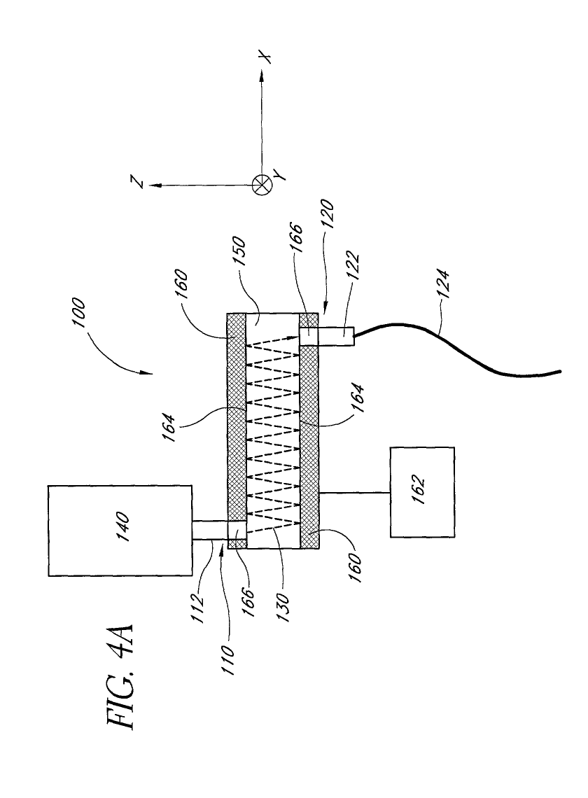

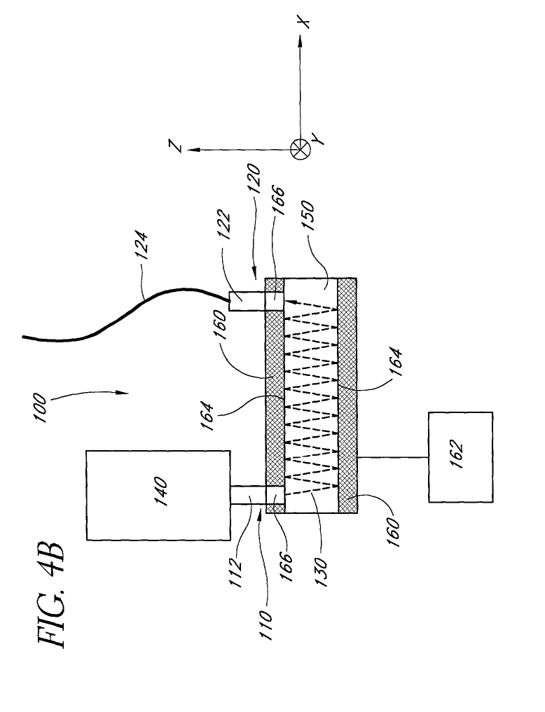

FIGS. 4A and 4B illustrate another alternative embodiment in which the optical path 130 is configured to propagate in a more parallel orientation with the applied electric field. Again, this embodiment is configured to reduce or substantially eliminate dependence on the polarization of the incoming collimated light beam 142. As described above, certain polycrystalline electro-optic materials, such as PLZT, exhibit birefringence upon application of an electric field causing light polarized perpendicular to the electric field to experience a different refractive index than light polarization parallel to the electric field. The embodiments illustrated in FIGS. 4A and 4B are configured such that neither polarization component of the collimated light beam 142 is parallel to the applied electric field. Specifically, in FIGS. 4A and 4B, the polarization components are in the xy plane, while the applied electric field is parallel to the z axis.

In the embodiments illustrated in FIGS. 4A and 4B, electrodes 160 are positioned on opposite sides of a region 150 of polycrystalline electro-optic material. Inner electrode surfaces 164 are positioned adjacent to the polycrystalline electro-optic material 150. The electrode 160 may comprise material such as metals that are reflective at the wavelength of operation. Alternatively, the opposite sides of the central region 150 may be coated with a material that reflects the input light beam 142. This coating may have an opening therein for light to pass. In such embodiments, electrodes 160 may contain electrode apertures 166 that are substantially optically transmissive of the input light beam 142 or the electrodes themselve may be substantially optically transmissive to the light. This configuration allows the input light beam 142 to be coupled into and out of the polycrystalline electro-optic material 150.

The light beam 142 coupled into the input port 110 will reflect multiple times from the opposite sides of the central region 150 until it reaches and passes through the output port 120. Accordingly, the electric field induced between the electrodes (in the ±z direction) will be substantially parallel to the propagation of the beam reflecting within the electro-optic material. Any polarization will therefore be perpendicular to the applied electric field. By providing multiple reflections, a variable attenuation may be accomplished even when the thickness of the central region 150 is small. Impractical, high applied voltages that would otherwise accompany thicker electro-optic regions 150 and electrodes 160 spaced farther apart, can thereby be avoided.

In certain embodiments, the input coupler 112 and output coupler 122 are butted against the electrode apertures 166. The input port 110 and optional input coupler 112 may be on different sides than the output port 112 and optional output coupler (as illustrated in FIG. 4A), or the input port and optional input coupler may be positioned on the same side as the output port and optical output coupler (as illustrated in FIG. 4B). Preferably, the input coupler 112 and the output coupler 122 comprise collimators and the input light beam 142 is substantially collimated. More preferably, this beam remains substantially collimated over the optical distance traveled by the beam from the input port 110 to the output port 120.

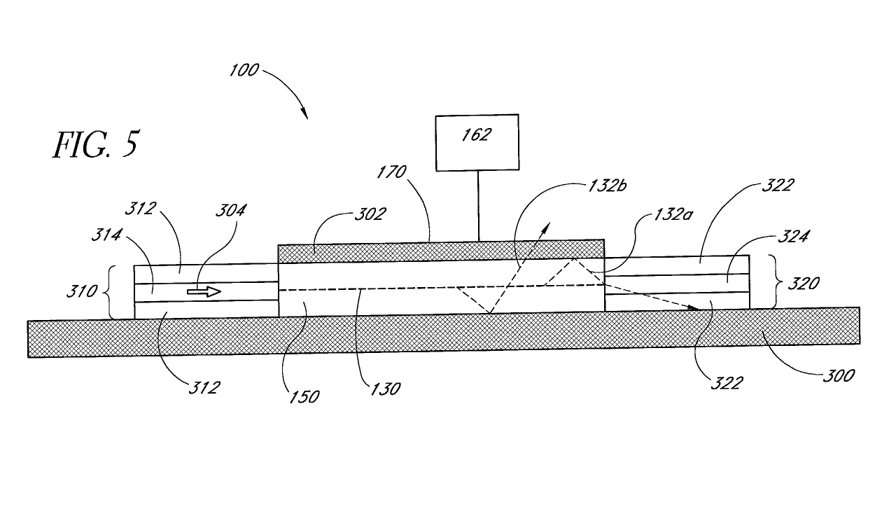

FIG. 5 illustrates the integration of an electro-optic modulator 100 onto a wafer substrate 300 with planar channel waveguides 310, 320. In such embodiments, the wafer substrate 300 preferably comprises a silicon substrate ground plane, although a buried electrode may be used if the waveguide is to be fabricated on a nonconductive substrate (such as glass or sapphire). Disposed on the wafer substrate 300 is a region 150 of polycrystalline electro-optic material, preferably PLZT. Disposed on a top surface 170 of the polycrystalline electro-optic material 150 is electrode 302, which is connected to modulation signal source 162. Input waveguide 310, which comprises low index regions 312 on opposite sides of a high index region 314, is configured to guided an optical signal 304 into the polycrystalline electro-optic material 150. Likewise, output waveguide 320, which comprises low index regions 322 on opposite sides of a high index region 324, is configured to transmit a portion of the light within the central region 150 of polycrystalline electro-optic material elsewhere on the substrate or to a remote location, for example, for detection or further signal processing etc., depending on the specific application.

The beam of light exiting the input waveguide 310 into the central region 150 may be divergent unless an optical element such as a collimator is inserted in the path of the beam. In the case where no collimating element 112 is provided, the length of the central region 150 is preferably short such that the beam does not expand in diameter beyond the dimensions of the central region; the light is therefore unguided within the central region 150 and propagates as if in free space. As discussed above, the length between the input and output ports 110 and 120 is preferably less than or equal to about one Rayleigh range of the beam within the central region 150. Preferably, for example, the central region 150 is about 0.5 mm to 3 mm long, is 0.1 mm to 1 mm high and 0.5 mm to 10 mm wide although dimensions outside these ranges are possible. In other embodiments, the central region 150 is not a free space region but is sufficiently small to guide the light propagating therethrough.

The waveguide electro-optic modulator 100 illustrated in FIG. 5 operates in substantially the same manner as the other electro-optic modulators described above. Application of an electric field to the polycrystalline electro-optic material 150 causes a decreased amount of optical energy to be coupled into output waveguide 320. For example, application of an electric field to the polycrystalline electro-optic material 150 may cause a portion of the optical energy propagating along the central optical path 130 to deviate and to instead propagate along deviant optical paths 132a which are outside the angle of acceptance of output waveguide 320. Alternatively, in embodiments wherein the electrode 302 is transparent, application of an electric field to the polycrystalline electro-optic material 150 may cause a portion of the optical energy propagating along optical path 130 to instead propagate along deviant optical paths 132b which are transmitted out the top and bottom 170 or sides of the central region 150 of polycrystalline electro-optic material. In this manner, a portion of the light within the input waveguide 310 can be selectively discarded and another portion coupled into the output waveguide 320.

Accordingly, the level of transmission or alternatively the amount of attenuation can be controlled, and the intensity of light output from the modulator can be varied as desired. Such functionality will find use in numerous applications such as for example for modulating data, voice, and video signals. Employment of these devices and systems are not, however, limited to optical communication but may be utilized in connection with medical, military, manufacturing, aerospace, instrumentation, experimental, computer and other applications not recited herein.

Although the foregoing description of the preferred embodiments of the present invention show, describe and point out the fundamental novel features of the invention described herein, it will be understood that various omissions, substitutions and changes in the form of the detail of the apparatus and method as illustrated, as well as the uses thereof, may be made by those of ordinary skill in the art without departing from the true spirit and scope of the present invention. Accordingly, the scope of the present invention should not be limited to the foregoing discussion, but should be defined by the appended claims.

What is claimed is:

1. An optical apparatus comprising:
an input port for receiving light,
an output port for outputting light,
an optical path extending from the input port to the output port, the optical path at least partially comprised of polycrystalline electro-optic material, and
a field generator that generates a field in the polycrystalline electro-optic material,
wherein the polycrystalline electro-optic material is configured with respect to the input port and the output port and is responsive to the field to cause at least a substantial portion of light propagating along the optical path to deviate from the optical path along a plurality of deviant optical paths that do not pass through the output port, thereby reducing light output through the output port.

2. The optical apparatus of claim 1, further comprising an optical source that produces light that is received by said input port.

3. The optical apparatus of claim 2, wherein said optical source comprises a laser.

4. The optical apparatus of claim 1, further comprising a reflective, refractive, or diffractive optical element at said input port for controlling said light received at said input port.

5. The optical apparatus of claim 4, wherein said a optical element comprises a collimator for producing a substantially collimated beam.

6. The optical apparatus of claim 5, wherein said collimator comprises a lens.

7. The optical apparatus of claim 4, wherein said collimator has a Rayleigh range at least about as long as said optical path.

8. The optical apparatus of claim 1, wherein the field generator comprises first and second electrodes, said polycrystalline electro-optic material disposed between said electrodes such that an electric field can be generated in at least a first portion of said polycrystalline electro-optic material.

9. The optical apparatus of claim 8, wherein said first and second electrodes include openings, said optical path extending from said opening in said first electrode to said opening in said second electrode.

10. The optical apparatus of claim 8, wherein said input port is at said first electrode and said output port is at said second electrode such that said electric field between said electrodes is substantially parallel to said optical path between said input and output ports.

11. The optical apparatus of claim 10, wherein said first and second electrodes are reflective and said light received by said input port is reflected back between said first and second electrodes and through said output port.

12. The optical apparatus of claim 8, wherein both said input and output ports are at said first electrode, said light received by said input port being reflected from a location opposite said first electrode back to said output port such that said electric field between said electrodes is substantially parallel to said optical path.

13. The optical apparatus of claim 12, wherein said second electrode is reflective and said light received by said input port is reflected back to said first electrode and through said output port.

14. The optical apparatus of claim 12, further comprising third and fourth electrodes, and at least a second portion of said polycrystalline electro-optic material disposed between said third and fourth electrodes, such that an electric field can be generated in said second portion polycrystalline electro-optic material that is substantially perpendicular to said electric field in said first portion of polycrystalline electro-optic material.

15. The optical apparatus of claim 14, wherein said first and second portions of polycrystalline electro-optic material are separated by a distance.

16. The optical apparatus of claim 15, wherein said first and second portions of polycrystalline electro-optic material are optically coupled together via a waveguide.

17. The optical apparatus of claim 16, wherein said waveguide optically coupling said first and second portions of polycrystalline electro-optic material comprises an optical fiber.

18. The optical apparatus of claim 14, wherein said first and second portions of polycrystalline electro-optic material are adjacent and in contact.

19. The optical apparatus of claim 18, wherein said first and second portions of polycrystalline electro-optic material are sections of a single volume of polycrystalline electro-optic material.

20. The optical apparatus of claim 1, wherein said polycrystalline electro-optic material has sufficient dimensions such that said light propagating along said optical path is substantially unguided therein.

21. The optical apparatus of claim 1, wherein said polycrystalline electro-optic material comprises PLZT.

22. The optical apparatus of claim 1, further comprising a waveguide optically coupled to said output port for receiving light output from said output port.

23. The optical apparatus of claim 22, wherein said waveguide optically coupled to said output port comprises an optical fiber.

24. The optical apparatus of claim 22, wherein said waveguide optically coupled to said output port comprises a planar waveguide.

25. The optical apparatus of claim 1, further comprising a waveguide optically coupled to said input port for delivering light to said input port.

26. The optical apparatus of claim 25, wherein said waveguide optically coupled to said input port comprises an optical fiber.

27. The optical apparatus of claim 25, wherein said waveguide optically coupled to said input port comprises a planar waveguide.

28. A method comprising:
transmitting light through a polycrystalline electro-optic material from an input port to an output port along an optical path;
outputting light through the output port;
reducing the flux density of the light output through the output port by activating the polycrystalline electro-optic material such that the flux density at a plurality of locations around the output port is increased.

29. The method of claim 28, further comprising coupling said light to said input port through a waveguide.

30. The method of claim 29, further comprising coupling said light to said input port through an optical fiber.

31. The method of claim 28, further comprising collimating said light transmitted though said polycrystalline electro-optic material.

32. The method of claim 28, wherein said light transmitted through said polycrystalline electro-optic material along said path from said input port to said output port is substantially unguided.

33. The method of claim 28, wherein said polycrystalline electro-optic material is activated by passing an electric field therethrough.

34. The method of claim 33, wherein said polycrystalline electro-optic material is activated by passing two orthogonally directed electric fields therethrough.

35. The method of claim 33, wherein said polycrystalline electro-optic material is activated by passing an electric field through said electro-optic material substantially parallel to said optical path between said input port and said output port.

36. The method of claim 35, wherein said light is reflected back and forth within said polycrystalline electro-optic material.

37. The method of claim 28, wherein said polycrystalline electro-optic material is activated in a manner such that said reduction of the flux density of the light is substantially independent of the polarization of the light at the input port.

38. A method comprising:
propagating light through a volume of polycrystalline electro-optic material;
outputting at least a portion of the light propagating through the volume of polycrystalline electro-optic material;
applying a sufficiently high electric field to scatter the propagated light and to reduce the portion of light output.

39. The method of claim 38, further comprising collimating said light propagated through said volume of polycrystalline electro-optic material.

40. The method of claim 38, wherein said light propagated through said polycrystalline electro-optic material is substantially unguided.

41. The method of claim 38, wherein two orthogonally directed electric fields are applied to said polycrystalline electro-optic material.

42. The method of claim 38, further comprising coupling light into said volume of polycrystalline electro-optic material.

43. The method of claim 42, wherein said electric field applied is orthogonal to the polarization of a substantial portion of said light coupled into said volume of polycrystalline electro-optic material.

44. The method of claim 43, wherein said light is reflected back and forth within said polycrystalline electro-optic material.

45. The method of claim 37, wherein electric field is applied in a manner such that said reduction in the light output is substantially independent of the polarization of the light directed into the volume of polycrystalline electro-optic material.

46. An optical apparatus comprising:
a light source for producing light;
an collimator for receiving said light from said light source and outputting a substantially collimated beam,
a modulator for modulating said collimated beam, said modulator comprising a length polycrystalline electro-optic material disposed between a pair of electrodes for inducing an electric field in said polycrystalline electro-optic material.

47. The optical apparatus of claim 46, wherein said collimated beam has a Rayleigh range about at least as long as said length of polycrystalline electro-optic material.

48. The optical apparatus of claim 46, wherein said collimator comprises a graded index (GRIN) lens.
